(19) United States
(12) Patent Application Publication
(10) Pub. No.: US 2008/0248287 A1
(43) Pub. Date: Oct. 9, 2008

(54) Gas Barrier Coating Having High Thermal Resistance

(75) Inventors: Derek R. Illsley, Kent (GB); Michael W. Leonard, Kent (GB)

Correspondence Address: DICKSTEIN SHAPIRO, 1177 AVENUE OF THE AMERICAS (6TH AVENUE), NEW YORK, NY, 10036-2714, US

(73) Assignee: Sun Chemical Corp., Parsipanny, NJ (US)

(21) Appl. No.: 12/089,835

(22) PCT Filed: Oct. 26, 2006
(86) PCT No.: PCT/US06/41609

§ 371 Date: Apr. 10, 2008

(30) Foreign Application Priority Data
Oct. 28, 2005 (GB) 0522043.9

(51) Int. Cl. B32B 5/16; C08K 3/34; B05D 3/02

(52) U.S. Cl. 428/327; 524/493; 427/387

(57) ABSTRACT

A coating composition comprising a silylated polyvinyl alcohol and colloidal silica in an aqueous vehicle, where the solids content of the composition is not greater than 7.5% w/w, the silyl monomer content of the silylated polyvinyl alcohol is not greater than 3.0% (based on the monomers forming the silylated polyvinyl alcohol), the silylated polyvinyl alcohol comprises at least 50% w/w of the solids content of the composition, and the average particle size of the colloidal silica is from 5 to 80 nm, may be coated on a substrate with a layer of an inorganic compound to form a gas barrier lamella.

The present invention relates to a coating composition which may be used to produce a plastics lamella, which may be single ply or a laminate, which is retortable, which has gas barrier properties and which may be used as packaging for a variety of materials, notably foods and pharmaceuticals, where exposure to oxygen needs to be eliminated or restricted and where the packaged material needs to be retorted in order to sterilise it.

Synthetic plastics materials have long been used for the packaging of foods and other materials which need protection from handling and from moisture. However, in recent years, it has become appreciated that, in addition, many foods and other sensitive materials benefit from being protected from atmospheric oxygen. A wide variety of multilayer laminate structures has been developed to provide barrier properties and other performance characteristics suited to a pack's purpose. These laminates may be any combination of plastic, metal or cellulosic substrates, and may include one or more coating or adhesive layers. Laminates which include polymeric films having metals or inorganic compounds, such as silicon oxides, deposited thereon have been found to give good general barrier properties and are widely used. However, their properties tend to be very temperature dependent and they may lose their ability to prevent the ingress of oxygen altogether at high temperatures, for example when the packaged material is retorted in order to sterilise and/or cook it. Moreover, the inorganic layer of these types of laminate is rather brittle and may crack or break when the laminate is flexed, resulting in a loss of the gas barrier properties.

As a result, a number of other laminated films have been proposed for this purpose. For example, EP 0 878 495 describes and claims a gas barrier laminated material comprising a substrate, an inorganic compound thin-film layer and a protective layer which are laminated in that order, where the protective layer is formed by coating on the inorganic compound thin-film layer a water-based coating composition containing a water-soluble polymer and at least one of (a) a metal alkoxide or a hydrolysate thereof and (b) a tin chloride, followed by heat drying. Other patents using similar techniques include EP 1 211 295 (JSR), EP 0 960 901 (Nakato) and U.S. Pat. No. 6,337,370. Although good oxygen barrier performance is achieved, there are a number of drawbacks with this technology. These drawbacks include having to prepare the hydrolysed silane press-side (due to poor long term stability), the exothermic nature of the hydrolysis reaction and the potential hazards associated with having to handle the silane and hydrochloric acid or other acid. Furthermore, the water resistance of these coatings can be insufficient.

US 2004/0014857 (Wacker) describes the use of silane-containing polyvinyl alcohols to achieve abrasion resistant coating slips, in particular coating slips for coating inkjet recording materials.

EP 0 123 927 describes and claims the synthesis of a silylated polyvinyl alcohol (PVA) and its formulation into water-resistant compositions. The silylated PVA is produced by the copolymerisation of vinyl acetate and vinyl alkoxy silanes (such as vinyl triethoxy silane), followed by hydrolysis of the acetate groups. Water resistant compositions are obtained by blending this silylated PVA with inorganic particulate material such as clay or silica. These compositions are said to have excellent defogging properties. Other patents describing similar compositions include JP2005194600A2, JP2005194471A2, JP2000290580A2, and US 2004/0054069.

We have now surprisingly found that compositions of the type disclosed in EP 0 123 927 have excellent gas barrier properties and so can be used as components of packaging materials for foodstuffs, pharmaceuticals and other materials that need to be protected from the atmosphere. However, in order to achieve good gas barrier properties combined with good retortability, it is necessary to maintain the components of the coating composition within strict limits.

Thus, in a first aspect, the present invention consists in a coating composition comprising a silylated polyvinyl alcohol and colloidal silica in an aqueous vehicle, wherein the solids content of the composition is not greater than 7.5% w/w, the silyl monomer content of the silylated polyvinyl alcohol is not greater than 3.0% (based on the monomers forming the silylated polyvinyl alcohol), the silylated polyvinyl alcohol comprises at least 50% w/w of the solids content of the composition, and the average particle size of the colloidal silica is from 5 to 80 nm.

In a second aspect, the invention consists in a process for preparing a gas barrier lamella, which comprises applying a composition of the present invention to a flexible substrate and removing the aqueous vehicle.

In a further aspect, the invention consists in a gas barrier lamella comprising a flexible plastics film coated with a first coating comprising an inorganic compound and a second coating comprising a silylated polyvinyl alcohol having dispersed therethrough a particulate silica, wherein the silyl monomer content of the silylated polyvinyl alcohol is not greater than 3.0% (based on the monomers forming the silylated polyvinyl alcohol), the silylated polyvinyl alcohol comprises at least 50% w/w of the solids content of the total weight of silylated polyvinyl alcohol and silica, and the average particle size of the colloidal silica is from 5 to 80 nm.

As used herein, the term “silylated polyvinyl alcohol” means a polymer containing both vinyl alcohol units and silyl units. In addition, it may contain units derived from other monomers, for example: olefins, such as ethylene or propylene; acrylic or methacrylic acid esters, such as methyl acrylate or ethyl methacrylate; other vinyl monomers, such as vinyl acetate; or styrene or derivatives thereof, such as methylstyrene.

There is no particular restriction upon the nature of the silylated polyvinyl alcohol used in the present invention, other than that it should be appropriate to the intended use of the gas barrier coating, and it may be any polyvinyl alcohol having a silicon atom in the molecule. Such silylated polyvinyl alcohol may, for example, be prepared by: silylating a polyvinyl alcohol or a modified polyvinyl acetate which contains hydroxy and/or carboxy groups; saponifying a copolymer of a vinyl ester and an olefinically unsaturated monomer containing silyl groups; or saponifying a polyvinyl ester having a terminal silyl group(s), which may be obtained by polymerising a vinyl ester in the presence of a silyl mercaptan. More generally, they may be prepared as described in EP 0 123 927, JP2005194600A2, JP2005194471A2, JP2000290580A2, and US 2004/0054069. It may also be prepared by the copolymerisation of vinyl alcohol (or a precursor thereof) with a silyl group-containing monomer, such as vinyltrimethoxysilane.

The proportion of silyl groups in the silylated polyvinyl alcohol is critical to the present invention. Thus, in accordance with the present invention, the silyl monomer content of the silylated polyvinyl alcohol is not greater than 3.0% (based on the monomers forming the silylated polyvinyl alcohol), and is preferably at least 0.2%. Thus, the preferred range is from 0.2 to 3.0%. More preferably, the silyl monomer content is less than 2.0%, and so a further preferred range is from 0.2 to 2.0%, most preferably from 0.4 to 2.0%. These percentages are calculated as the proportion of silyl group-containing monomer units to total monomer units.

The degree of saponification may likewise vary over a wide range, for example from 70 to 100 mol %.

The amount of the silylated polymer is at least 50% of the dry weight of the coating comprising a silylated polyvinyl alcohol and the silica, more preferably at least 60%. Preferably the amount does not exceed 90 or 95%. A preferred range is from 90 to 50%, more preferably from 90 to 60%.

Dispersed through the silylated polyvinyl alcohol is a particulate silica. This is used in the coating composition of the present invention as a colloidal silica. The amount of the silica used is also important to the achievement of the benefits of the present invention. On the one hand, if too little is present, the beneficial effect may be too small to be of much practical benefit. On the other hand, if too much is present, it will adversely affect the properties of the film on which it is coated. The amount should not exceed 50% of the dry weight of the coating comprising the silylated polyvinyl alcohol and the colloidal silica, more preferably it should not exceed 40% of the dry weight of the coating comprising a silylated polyvinyl alcohol and the inorganic compound. On the other hand, we prefer that the amount should not be less than 5% of the dry weight of the coating comprising a silylated polyvinyl alcohol and the inorganic compound. More preferably, the amount is from 10 to 50% of the dry weight of the coating comprising a silylated polyvinyl alcohol and the inorganic compound.

In order that the coating composition of the present invention should not gel while stored, the solids content should not exceed 7.5%. More preferably, it is at least 0.5%, and a preferred range is from 0.5 to 7.5%, most preferably from 1.5 to 5.0% w/w.

The particle size of the silica should be from 5 to 80 nm, more preferably from 5 to 50 nm, still more preferably from 5 to 40 nm and most preferably from 10 to 30 nm.

In the process of the present invention, this coating composition is applied to a substrate and then the aqueous vehicle is removed, e.g. by heating. The resulting gas barrier lamella may be a single ply lamella, or it may form part of more complex multilayer laminate structure which can include one or more additional substrates, adhesive coatings, layers of inks and varnishes, etc., as is well-known to those skilled in the art. It is preferred that the lamella of the present invention should be adhered to a further flexible plastics sheet.

There is no particular restriction on the nature of the flexible substrate, although it is preferably a plastics film, and any material suitable for the intended use may be employed. However, where the matter being packaged with the lamella of the present invention is a foodstuff or pharmaceutical, it will normally be preferred that the plastics film or other substrate should be food grade. Examples of suitable materials include: polyolefins, such as polyethylene or polypropylene; polyesters, such as polyethylene terephthalate, polybutylene terephthalate or polyethylene naphthenate; polyamides, such as nylon-6 or nylon-66; and other polymers, such as polyvinyl chloride, polyimides, acrylic polymers, polystyrenes, celluloses, or polyvinylidene chloride. It is also possible to use copolymers of any compatible two or more of the monomers used to produce these polymers. We especially prefer the polyesters.

Where there is a further plastics sheet, this, too, should be flexible and may be selected from any of the materials exemplified in the preceding paragraph.

Where the gas barrier lamella of the present invention has a first coating on the flexible plastics film, this is of an inorganic compound. As with the plastics film, the nature of this will be determined by the intended use of the gas barrier lamella of the present invention, and, where the lamella is for use as packaging for foodstuffs or pharmaceuticals, the inorganic compound should be of food grade. Examples of such compounds include: aluminium compounds, such as aluminium oxide, and silicon compounds, such as silicon oxides SiOₓ.

The thickness of this first coating will depend in part on the nature of the inorganic compound and its ability to form a continuous, coherent coating layer. However, in general, we prefer that the coating should be from 1 nm to 1000 nm thick, more preferably from 20 to 100 nm thick.

Where there is a first coating, the second coating on the plastics film may be on the same side of the film as the first coating or it may be on the opposite side. In the former case, the second coating coated is on the surface of the first coating. The second coating comprises a silylated polyvinyl alcohol having dispersed therethrough a particulate inorganic compound having a maximum cross-sectional dimension of 100 nm. The thickness of this second coating is preferably from 0.05 μm to 2.5 μm, more preferably from 0.1 μm to 1.0 μm (dry coat film thickness).

The invention also provides a process for preparing the gas barrier lamella of the present invention, which comprises:
applying to a flexible plastics film a first coating (where used) comprising an inorganic compound and a second coating comprising the coating composition of the present invention; and
heating the resulting coated film to a temperature sufficient to cure the silylated polyvinyl alcohol.

The first coating (where used) and the second coating may be applied in any order, i.e. the first coating may be applied first and the second coating may be applied second, or the first coating may be applied second and the second coating applied first, or the first and second coatings may be applied at the same time. Also, the first coating may be applied before or after the film coated with the second coating is heated to cure

The invention still further provides a packaged foodstuff, pharmaceutical or other material sensitive to the atmosphere, wherein the packaging comprises a gas barrier lamella of the present invention.

The invention is further illustrated by the following non-limiting Examples.

### EXAMPLES

In these Examples, the coatings were prepared in an aqueous solution with 6% (w/w) of isopropanol. The oxygen transmission rates of the coated samples were determined on a Mocon Oxtran 2/21 gas permeability tester at 23° C. and 50% relative humidity. The substrate used in all cases was a 12 μm gauge polyester substrate (Melinex 800) with an aluminium oxide surface treatment (of approximately 40 nm thickness). The coatings were applied with a No. 2 K-bar and were dried in a warm flow of air (laboratory prints were dried with a hair dryer).

The laminates were prepared by applying an adhesive to the polyamide surface of a pre-formed 25 μm polyamide-75 μm cast polypropylene laminate and then forming the final laminate by applying the coated surface of the aluminium oxide/polyester substrate to the adhesive layer on the polyamide surface. The adhesive used was supplied by Rohm & Hass, Adcote 811A along with Catalyst 9L10, and was prepared according to the manufacturers instructions and applied so as to achieve a final dry film weight of 4 gsm. The laminates were then stored for 10 days at 50° C. to ensure full cure of the isocyanate-based adhesive.

The laminates were then tested for bond strength (N/15 mm) and oxygen barrier both before and after retort. The retort test was 30 minutes at 130° C. (a high temperature steam sterilization process). The laminates were also visually inspected after retort to assess for any signs of delamination. If the laminates showed severe delamination then the oxygen transmission rate was not always measured.

### Example 1 (Comparative)

### Aluminium Oxide/Polyester Substrate Alone

Before retort the oxygen transmission rate was measured at 4.5-6.5 cm3/m2/24 h, and the test for bond strength resulted in the polyester film tearing. After retort, the oxygen transmission rate was measured at between 10.0-15.0 cm3/m2/24 h and the polyester film tore during the bond strength test.

### Example 2 (Comparative)

Aluminium Oxide/Polyester Substrate Coated with a Composition Prepared According to EP 0 878 495

8.9 g of tetraethyl orthosilicate in 18.4 g of water and 18.4 g of ethanol along with 0.8 g of 0.1N HCl were stirred for 30 minutes. Then, 3.9 g of 12% (w/w) of PVA (Celvol 103) were added and the subsequent coating was applied to the aluminium oxide/polyester substrate at an approximate wet film thickness of 10 μm. The coating was then dried at 120° C. for 90 seconds before preparing the laminate.

Before retort, the oxygen transmission rate was 1.5 cm3/m2/24 h and the polyester film tore during the bond strength test. After retort, the oxygen transmission rate was 7.1 cm3/m2/24 h and the polyester film tore during the bond strength test.

### Example 3 (Comparative)

Aluminium Oxide/Polyester Substrate Coated with a Silylated-Polyvinyl Alcohol (PVA)

The aluminium oxide/polyester substrate was coated with a 4% (w/w) solution of a silyl-group functional PVA, defined as ‘A’ in Table 1, where the concentration of the silyl-group containing monomer in the polymer backbone was 1.6% (w/w of monomer composition). Before retort, the laminate had an oxygen transmission rate of 0.25 cm3/m2/24 h and the polyester film tore during the bond strength test. After retort, the laminate showed severe delamination with a bond strength of less than 0.5N/15 mm. Due to the severe delamination it was not possible to obtain an accurate oxygen transmission rate reading.

### Example 4

A coating was prepared by blending 3.0 g of isopropyl alcohol with 19.3 g of water, 17.1 g of a 7.25% (w/w) solution of the PVA described in Example 3, and 0.46 g of a colloidal silica with a particle size of 15 nm, a concentration of 40% and a pH of 9.5 (Bindzil 40/220, ex. EKA). This coating was applied to the aluminium oxide/polyester substrate at a wet coating film weight of 10-12 gsm and air dried. The laminate was formed in the usual manner.

Before retort, the oxygen transmission rate was less than 0.1 cm3/m2/24 h and the bond strength test resulted in film tear of the polyester. After retort, there were no observable signs of delamination and the oxygen transmission rate was 0.20 cm3/m2/24 h and the polyester film tore during the bond strength test.

### Examples 5 to 30

Using the silylated PVA as described in Example 3, coatings were prepared with alkaline colloidal silicas of different particle sizes and concentrations as outlined in Table 1. The laminates were prepared and tested in the usual manner and the results for the post-retort tests are given.

TABLE 1
Effect of Colloidal Silica Particle Size on Laminate Properties After Retort

| | | Silica Particle | Concentration | Concentration | | Bond (2) | OTR (2) |
|---|---|---|---|---|---|---|---|
| Example | PVA | Size | PVA (A) | Silica (B) | Observation (1) | Post-Retort | Post-Retort |
| 5 | A | 6 nm | 3.8 | 0.2 | Slight Tunnelling | FT | 0.24 |
| 6 | A | 6 nm | 3.6 | 0.4 | No Delamination | FT | 0.37 |
| 7 | A | 6 nm | 3.2 | 0.8 | No Delamination | FT | 0.48 |
| 8 | A | 6 nm | 2.8 | 1.2 | No Delamination | FT | 9.26 |
| 9 | A | 6 nm | 2.4 | 1.6 | No Delamination | FT | 16.83 |
| 10 | A | 9 nm | 3.8 | 0.2 | No Delamination | FT | 0.45 |
| 11 | A | 9 nm | 3.6 | 0.4 | No Delamination | FT | 0.11 |
| 12 | A | 9 nm | 3.2 | 0.8 | Some Blisters | FT | 1.14 |
| 13 | A | 9 nm | 2.8 | 1.2 | Some Blisters | FT | 2.29 |
| 14 | A | 9 nm | 2.4 | 1.6 | Some Blisters | FT | >10.0 |
| 15 | A | 15 nm | 3.8 | 0.2 | Tunnelling | 2.2 | 0.24 |
| 16 | A | 15 nm | 3.6 | 0.4 | Some Blisters | 2.2 | — |
| 17 | A | 15 nm | 3.2 | 0.8 | No Delamination | 2 | 0.14 |
| 18 | A | 15 nm | 2.8 | 1.2 | No Delamination | FT | <0.10 |
| 19 | A | 15 nm | 2.4 | 1.6 | No Delamination | FT | 2.06 |
| 20 | A | 15 nm | 2 | 2 | No Delamination | FT | 13.54 |
| 21 | A | 20 nm | 3.8 | 0.2 | No Delamination | FT | 0.21 |
| 22 | A | 20 nm | 3.6 | 0.4 | No Delamination | FT | 0.76 |
| 23 | A | 20 nm | 3.2 | 0.8 | No Delamination | FT | 0.74 |
| 24 | A | 20 nm | 2.8 | 1.2 | No Delamination | FT | 1.1 |
| 25 | A | 20 nm | 2.4 | 1.6 | Slight Tunnelling | FT | 2.67 |
| 26 | A | 100 nm | 3.8 | 0.2 | Some Tunnelling | 2.5 | 1.05 |
| 27 | A | 100 nm | 3.6 | 0.4 | Some Tunnelling | FT | 0.99 |
| 28 | A | 100 nm | 3.2 | 0.8 | Some Tunnelling | FT | >10 |
| 29 | A | 100 nm | 2.8 | 1.2 | Some Tunnelling | 2.7 | 1.23 |
| 30 | A | 100 nm | 2.4 | 1.6 | No Delamination | FT | 1.33 |

(A), (B): Concentrations given in terms of weight % in a 94/6 blend of water/Isopropanol.
The PVA used in this series of examples (‘A’) had a nominal Si-monomer content of 1.6% (w/w)
(1). The observation describes any visible signs of delamination after retort at 130 C. for 30 minutes
(2). The bond strength is given as the force required to separate the coated polyester from the remainder of the laminate in N/15 mm. Where the bond strength is too great and results in the polyester film tearing or breaking this is given as ‘FT’ in Table 1.
3. OTR (Oxygen Transmission Rate): Measured on a Mocon Oxtran 2/21 at 23 C. and 50% relative humidity. (cm3/m2/24 h)

### Examples 31 to 48

Using the 15 nm colloidal silica (Bindzil 40/220), coating compositions with a total solids content of 4% (w/w) were prepared with a number of different silylated PVAs as described in Table 2. The laminates were tested in the usual way and the post-retort results are shown in Table 2.

TABLE 2
Alternative Silylated Poly(Vinyl Alcohol)s

| | | Silica Particle | Concentration | Concentration | | Bond (N/15 mm) | OTR |
|---|---|---|---|---|---|---|---|
| Example | PVA (A) | Size | PVA | Silica | Observation | Post-Retort | Post-Retort |
| 31 | R-3109 | 15 nm | 3.8 | 0.2 | Some Tunnelling | 1.7 | — |
| 32 | R-3109 | 15 nm | 3.6 | 0.4 | Some Tunnelling | 1.6 | — |
| 33 | R-3109 | 15 nm | 3.2 | 0.8 | Some Tunnelling | 2.7 | — |
| 34 | R-3109 | 15 nm | 2.8 | 1.2 | No Delamination | FT | 0.413 |
| 35 | R-3109 | 15 nm | 2.4 | 1.6 | No Delamination | FT | 0.338 |
| 36 | R-3109 | 15 nm | 2 | 2 | No Delamination | FT | 10.09 |
| 37 | R-2105 | 15 nm | 3.8 | 0.2 | Tunnelling | FT | — |
| 38 | R-2105 | 15 nm | 3.6 | 0.4 | Some Tunnelling | FT | — |
| 39 | R-2105 | 15 nm | 3.2 | 0.8 | Some Tunnelling | 2.1 | — |
| 40 | R-2105 | 15 nm | 2.8 | 1.2 | Slight Tunnelling | 2.2 | 0.17 |
| 41 | R-2105 | 15 nm | 2.4 | 1.6 | No Delamination | 1.5 | 7.77 |
| 42 | R-2105 | 15 nm | 2 | 2 | No Delamination | FT | 29.82 |
| 43 | R-1130 | 15 nm | 3.8 | 0.2 | No Delamination | FT | 0.11 |
| 44 | R-1130 | 15 nm | 3.6 | 0.4 | No Delamination | FT | 0.14 |
| 45 | R-1130 | 15 nm | 3.2 | 0.8 | No Delamination | FT | 0.18 |
| 46 | R-1130 | 15 nm | 2.8 | 1.2 | No Delamination | FT | <0.1 |
| 47 | R-1130 | 15 nm | 2.4 | 1.6 | No Delamination | FT | <0.1 |
| 48 | R-1130 | 15 nm | 2 | 2 | No Delamination | FT | 23.24 |

(A). The silylated PVAs shown in Table 2 are commercially available from Kuraray.

1. A coating composition comprising a silylated polyvinyl alcohol and colloidal silica in an aqueous vehicle, wherein the solids content of the composition is not greater than 7.5% w/w, the silyl monomer content of the silylated polyvinyl alcohol is not greater than 3.0% (based on the monomers forming the silylated polyvinyl alcohol), the silylated polyvinyl alcohol comprises at least 50% w/w of the solids content of the composition, and the average particle size of the colloidal silica is from 5 to 80 nm.

2. A composition according to claim 1, in which said solids content is at least 0.5% w/w.

3. A composition according to claim 1, in which said solids content is from 1.5 to 5.0% w/w.

4. A composition according to claim 1, in which the silyl monomer content of the silylated polyvinyl alcohol is at least 0.2%.

5. A composition according to claim 1, in which the silyl monomer content of the silylated polyvinyl alcohol is less than 2.0%.

6. A composition according to claim 5, in which the silyl monomer content of the silylated polyvinyl alcohol is from 0.4 to 2.0%.

7. A composition according to claim 1, in which the silylated polyvinyl alcohol comprises at least 60% w/w of the solids content of the composition.

8. A composition according to claim 7, in which the silylated polyvinyl alcohol comprises from 60 to 90% w/w of the solids content of the composition.

9. A process for preparing a gas barrier lamella, which comprises applying a composition according to claim 1 to a flexible substrate and removing the aqueous vehicle.

10. A process according to claim 9, in which a coating comprising an inorganic compound is also applied.

11. A process according to claim 10, in which the inorganic compound is aluminium oxide.

12. A process according to claim 10, in which the inorganic compound is silicon oxide.

13. A process according to claim 10, in which the coating comprising the silylated polyvinyl alcohol and the colloidal silica is coated on the coating comprising the inorganic compound.

14. A process according to claim 10, in which the coating comprising the silylated polyvinyl alcohol and the colloidal silica is coated on the side of the substrate opposite the coating comprising the inorganic compound.

15. A process according to claim 10, in which the substrate is a flexible plastics film.

16. A gas barrier lamella comprising a flexible plastics film coated with a first coating comprising an inorganic compound and a second coating comprising a silylated polyvinyl alcohol having dispersed therethrough a particulate silica, wherein the silyl monomer content of the silylated polyvinyl alcohol is not greater than 3.0% (based on the monomers forming the silylated polyvinyl alcohol), the silylated polyvinyl alcohol comprises at least 50% w/w of the solids content of the total weight of silylated polyvinyl alcohol and silica, and the average particle size of the colloidal silica is from 5 to 50 nm.

17. A lamella according to claim 16, in which the silyl monomer content of the silylated polyvinyl alcohol is at least 0.2%.

18. A lamella according to claim 17, in which the silyl monomer content of the silylated polyvinyl alcohol is less than 2.0%.

19. A lamella according to claim 18, in which the silyl monomer content of the silylated polyvinyl alcohol is from 0.4 to 2.0%.

20. A lamella according claim 16, in which the silylated polyvinyl alcohol comprises at least 60% w/w of the total weight of silylated polyvinyl alcohol and silica.

21. A composition according to claim 20, in which the silylated polyvinyl alcohol comprises from 50 to 90% w/w of the total weight of silylated polyvinyl alcohol and silica.

22. A lamella according to claim 16, in which the substrate is a polyester.

23. A lamella according to claim 16, in which the inorganic compound of the first coating is aluminium oxide.

24. A lamella according to claim 16, in which the inorganic compound of the first coating is silicon oxide.

25. A lamella according to claim 16, in which the second coating is coated on the first coating.

26. A lamella according to claim 16, in which the second coating is coated on side of the flexible plastics film opposite the first coating.

27. A multi-layer lamella comprising a lamella according to claim 16, adhered to a further flexible plastics sheet.

28. A lamella according to claim 27, in which said further plastics sheet is a polyolefin, a polyester, a polyamide, a polyvinyl chloride, a polyimide, an acrylic polymer, a polystyrene, cellulose, a polyvinylidene chloride, or a copolymer of any compatible two or more of the monomers forming these polymers.

29. A package formed of a packaging material which comprises a lamella according to claim 16.

30. A packaged foodstuff, pharmaceutical or other material sensitive to the atmosphere, wherein the packaging comprises a lamella according to claim 16.
